(19) United States
(12) Patent Application Publication
(10) Pub. No.: US 2013/0029137 A1
(43) Pub. Date: Jan. 31, 2013

(54) Adhesive Sheet

(71) Applicants: Yuki Eto, Saitama (JP); Kazuyuki Tamura, Saitama (JP)

(72) Inventors: Yuki Eto, Saitama (JP); Kazuyuki Tamura, Saitama (JP)

(73) Assignee: LINTEC CORPORATION, Tokyo (JP)

(21) Appl. No.: 13/557,439

(22) Filed: Jul. 25, 2012

(30) Foreign Application Priority Data
Jul. 25, 2011 (JP) 2011-162390

(51) Int. Cl. C09J 7/02; B32B 27/00

(52) U.S. Cl. 428/336; 428/354

(57) ABSTRACT

An adhesive sheet includes a base film, an anchor coat layer including a compound having an energy ray polymerizable group, and an energy ray curable adhesive layer that are stacked in this order.

This U.S. application claims priority of Japanese patent document 2011-162390 filed on Jul. 25, 2011, the entirety of which is incorporated herein by reference.

### TECHNICAL FIELD

The present invention relates to an adhesive sheet, further specifically, the present invention relates to the adhesive sheet suitably used for fixing a plate-like member when processing the plate-like member, while protecting a fixed unprocessed face. Particularly, the present invention relates to the adhesive sheet suitable as a surface protection sheet, preferably used when fixing semiconductor wafer formed with a circuit on the frontside while protecting a circuit face, and when grinding a backside of the semiconductor wafer.

Recently, along with the wide spreading of IC card, it is demanded to be furthermore thinner. Accordingly, a conventionally used thinned semiconductor chip having approximately 350 μm thickness is required to be 50 to 100 μm thickness or even more thinner. This thinned semiconductor chip can be obtained by sticking the surface protection sheet on the circuit side of the wafer, and the backside grinding of the wafer, followed by the dicing of the wafer.

As for the surface protection sheet, various adhesive sheets wherein an adhesive layer is formed on a base film are used. Further, it is widely performed that the energy ray curable adhesive is used for the adhesive layer, and after a predetermined grinding process, adhesive strength is decreased by irradiating the energy-ray to the adhesive layer making release of the wafer easy. Accordingly, as for the energy ray curable type surface protection sheet, a polyolefin having a high bonding property with adhesive layer is generally used for a base (Patent Article 1).

However, it is required to grind a thinner wafer as mentioned above. In order to grind the wafer extremely-thin, a surface protection sheet having high thickness accuracy is demanded. When thickness of the surface protection sheet is non-uniform, said non-uniform of the sheet may influence the wafer and thickness of the wafer may become non-uniform or the wafer may break.

In order to improve a thickness accuracy of the surface protection sheet, a high thickness accuracy film is considered to be used as a surface protection sheet base. Polyester film such as polyethylene terephthalate film is known as a high thickness accuracy film. However, when the polyester film is used as a base, a phenomenon, which did not become a problem when the above-mentioned polyolefin is used as a base, became apparent. Namely, the energy ray-curable adhesive layer is cured by irradiating an energy ray in order to release by decreasing adhesiveness, but the cured layer by the energy ray may contract in volume compared to the state before the cure. Due to excellent smoothness of the polyester film surface and to rigidity of the polyester film, bonding property between a polyester film and an energy ray-curable adhesive layer may decrease in a surface protection sheet, where the energy ray-curable adhesive layer is stacked directly on the polyester film. As a result, when peeling the surface protection sheet from a semiconductor wafer, the energy ray curable adhesive may be released from the polyester film, and then the energy ray curable adhesive may transfer on a surface of the semiconductor wafer.

### PRIOR ART

[Patent Article 1] Japanese Laid-Open Publication No. 2003-82307

### SUMMARY OF INVENTION

Therefore, the objective of the present invention is to provide an adhesive sheet wherein an energy ray-curable adhesive layer will not be transferred to a wafer and the like, even when a polyester film is used for a base of an energy ray-curable adhesive sheet.

The subjects of the present invention are as follows.

(1) An adhesive sheet wherein a base film, an anchor coat layer including a compound having an energy ray polymerizable group, and an energy ray curable adhesive layer are stacked in this order.

(2) The adhesive sheet as set forth in (1), wherein said base film consists of polyester.

(3) The adhesive sheet as set forth in (2), wherein said polyester is polyethylene terephthalate.

(4) The adhesive sheet as set forth in any one of (1) to (3); wherein the energy ray polymerizable group included in the compound having the energy ray polymerizable group is a (meth)acryloyl group.

(5) The adhesive sheet as set forth in (4); wherein the compound having the energy ray polymerizable group is a polymer comprising (meth)acryloyl group.

(6) The adhesive sheet as set forth in (5); wherein the polymer comprising (meth)acryloyl group is a (meth)acrylate-modified polyester.

(7) The adhesive sheet as set forth in any one of (1) to (6); wherein the compound having energy ray polymerizable group has a reactive functional group other than the energy ray polymerizable group, and the anchor coat layer includes a cross-linker.

(8) The adhesive sheet as set forth in any one of (1) to (7); wherein the energy ray curable adhesive includes an acrylic polymer.

(9) The adhesive sheet as set forth in any one of (1) to (8); wherein the energy ray curable adhesive includes a multifunctional ultraviolet ray curable resin.

(10) The adhesive sheet as set forth in any one of (1) to (9); wherein a thickness of the anchor coat layer is 0.1 to 10 μm.

(11) The adhesive sheet as set forth in any one of (1) to (10) being used for an unprocessed face protection of plate-like member when processing the plate-like member.

(12) The adhesive sheet as set forth in (11) being used for a circuit face protection of a semiconductor wafer when grinding a backside of the semiconductor wafer.

At the present invention, a compound having energy ray polymerizable group is compounded in the anchor coat layer of a base film. By forming such anchor coat layer, the bonding property between base film and adhesive layer can be maintained even after the curing of the energy ray curable adhesive. Therefore, even when polyester film is used for a base of an adhesive sheet, the adhesive layer after the curing will not transfer to the wafer and the like.

Mechanism of such effects of the invention is not necessarily obvious but the inventors consider this as following. Namely, when curing the energy ray curable adhesive, at least a part of the energy ray polymerizable group included in the anchor coat layer is also polymerized, and a covalent bond is formed between a part of the adhesive layer and the anchor coat layer; thereby the bonding between the adhesive layer and the base is maintained via the anchor coat layer.

### BRIEF DESCRIPTION OF THE DRAWING

The sole FIGURE is a schematic diagram of an adhesive sheet according to an embodiment of the invention.

### DETAILED DESCRIPTION OF THE INVENTION

An adhesive sheet 1 according to the present invention is formed by stacking a base film 2, an anchor coat layer 3 comprising a compound having energy ray polymerizable group, and an energy ray curable adhesive layer 4, in this order.

(A base film)

Although a base film of adhesive sheet according to the present invention is particularly not limited, a film having high thickness accuracy such as a polyester film, a polycarbonate film, a polystyrene film, a polyphenylene sulfide film, a cycloolefin polymer film, and the like is preferably used. Also, the effect will be further preferably exhibited such as an improvement of the bonding property between the base film of the present invention and the energy ray curable adhesive layer even when smoothness of the base film surface is high or the rigidity of the base film is high.

Further, by adopting the configuration of the present invention, the bonding property between a base and an adhesive layer can be maintained even with a resin film with a low bonding property against the energy ray curable adhesive, such as polyester film. Namely, the present invention is notably effective by using the polyester film, and that the polyester film is particularly preferable for the base film of the invention. The polyester film has high thickness accuracy, and that the wafer is safely held even when grinding the wafer extremely-thin.

As for a polyester constituting polyester film, a polyester obtained by polycondensation of an aromatic diacid or ester derivatives thereof and a diol or ester derivatives thereof may be mentioned. As for a concrete example of the polyester, polyethylene terephthalate, polyethylene isophthalate, polybutylene terephthalate, polyethylene-2,6-naphthalenedicarboxylate or so may be mentioned and it may be their copolymers, blends wherein said polymers are blended with a relatively small amount of the other resins, and etc. may be included. Above all the polyester films, a polyethylene terephthalate film having high thickness accuracy and also which is easy to obtain is particularly preferable.

Although unstretched polyester film, a monoaxially-stretched polyester film and a biaxially-stretched polyester film can all be used for the polyester film, biaxially-stretched polyester film is preferable.

The polyester film can be manufactured with a conventionally known method. For instance, the biaxially-stretched polyester film can be manufactured with the following methods. After drying polyester, the polyester is melted at a temperature of Tm to (Tm+70)° C. (Tm: melting point of polyester) by an extruder, and extruded on a rotational cooling drum of 40 to 90° C. from die (e.g. T-die, I-die, and etc.), the unstretched polyester film is stretched at 2.5 to 8.0-fold in the longitudinal direction and 2.5 to 8.0-fold in the lateral direction under a temperature of (Tg−10) to (Tg+70)° C., then if necessary, it is heat fixed for 1 to 60 seconds under a temperature of 180 to 250° C.

Thickness of the base film is preferably within 5 to 250 μm. The deformation resistance (dimension stability) is poor when thickness of the base film is less than 5 μm at a high temperature range, while rigidity is too high when it exceeds 250 μm.

Suitable filler can be included in a base film, when necessary. As for the filler, conventionally known fillers giving lubricativeness to a base film may be mentioned. Specifically, calcium carbonate, calcium oxide, aluminum oxide, silica, kaolin, silicon oxide, zinc oxide, carbon black, silicon carbide, stannous oxide, crosslinked acrylic resin particles, crosslinked polystyrene resin particles, melamine resin particles, crosslinked silicone resin particles, and etc. may be mentioned. Further, in the base film, coloring agent, antistatic agent, antioxidizing agent, organic lubricant agent, catalyst, and etc. may be added.

The base film may be transparent, or may be colored or deposited when desired. The base film may further include ultraviolet absorbing agent, light stabilizer, antioxidizing agent, and the like. Further, the base film may be a single film as mentioned in above, or may be a stacked film.

### (An Anchor Coat Layer)

The anchor coat layer comprises a compound having energy ray polymerizable group. Energy ray polymerizable group is a group polymerized when irradiated by an energy ray such as ultraviolet rays or electron beam and for example, the group comprising the ethylene based unsaturated bond may be mentioned. In concrete, acryloyl group, methacryloyl group, vinyl group, aryl group, etc. are exemplified. Hereinafter, acryloyl group and methacryloyl group may be referred as (meth)acryloyl group. As for an energy ray polymerizable group, (meth)acryloyl group is particularly preferable due to an easiness of introduction and a good reactivity.

When a compound having the above energy ray polymerizable group is blended into anchor coat layer, the bonding property between the base film and the adhesive layer via the anchor coat layer is maintained even after curing the energy ray curable adhesive. Therefore, even when a polyester film is used as the base of the adhesive sheet, the cured adhesive layer will not transfer to the wafer.

Although a compound having an energy ray polymerizable group is not particularly limited as long as it includes energy ray polymerizable group as exemplified in above, a compound having (meth)acryloyl group is preferably used. By including a compound having (meth)acryloyl group, it is thought to improve an affinity with an acrylic polymer, generally included in the energy ray curable adhesive. Further, when curing with the energy ray, the energy curing component in the adhesive reacts with the (meth)acryloyl group included compound and forms a covalent bond between the adhesive layer and the anchor coat layer, and thereby the bonding property is maintained between the base film and the adhesive layer. Such effect of improving the bonding property between the base film and the adhesive layer is higher as the density of the presence of the energy ray polymerizable group in the anchor coat layer is large; and even if the energy ray curable adhesive layer has large volume contraction during the curing, the transferring of the energy ray curable adhesive layer to the adherend is tend to be prevented without decreasing the bonding property.

By using a polymer with relatively high molecular amount as a compound having (meth)acryloyl group, the cohesive property will be maintained merely by coating followed by drying the anchor coat due to a film forming property of the polymer itself, and easily forms the anchor coat layer.

On the other hand, by using a compound with relatively low molecular amount as a compound having (meth)acryloyl group, the cohesive property may not be sufficient merely by coating followed by drying the anchor coat. Thus, in order to improve the cohesion force of a general coat layer, the energy ray of which the output has been suppressed so that all of (meth)acryloyl group are not completely polymerized, is irradiated to pre-cure the coated film.

As for a polymer having (meth)acryloyl group, urethane acrylate and (meth)acrylate-modified polyester may be mentioned. Above all, (meth)acrylate-modified polyester has a polyester part, wherein a bonding property with polyester film is high, and that the bonding property between an anchor coat layer and polyester film further improves.

Further, compound having energy ray polymerizable group may include a reactive functional group other than the energy ray polymerizable group. As for the reactive functional group other than the energy ray polymerizable group, a carboxyl group, an amino group, a hydroxyl group, a glycidyl group, and isocyanate group may be mentioned. When a compound having energy ray polymerizable group has such reactive functional groups, a cross-linker which is reactable with these reactive functional groups may be added in the anchor coat layer. When the cross-linker, which reacts with the reactive functional group, is added, the cohesive property of the anchor coat layer becomes adjustable; and that the opposite properties of a bonding property with the energy ray curable adhesive and a blocking resistance property can be easily adjusted. As for the abovementioned cross-linker which reacts with reactive functional group, an aziridine cross-linker, an epoxy cross-linker, a isocyanate cross-linker, metal chelate cross-linker, and etc. are exemplified.

As examples of aziridine cross-linker, N,N′-diphenylmethane-4,4′-bis(1-aziridinecarboxyamide), trimethylolpropane-tri-β-aziridinyl propionate, tetramethylolmethane-tri-β-aziridinyl propionate, N,N′-toluene-2,4-bis(1-aziridinecarboxyamindo)triethylenemelamine or so may be mentioned.

As for examples of epoxy cross-linker, a bisphenol A epoxy compound, a bisphenol F epoxy compound, 1,3-bis(N,N-diglycidylaminomethyl)benzene, 1,3-bis(N,N-diglycidylaminomethyl)toluene, N,N,N′N′-tetraglycidyl-4,4-diaminodiphenylmethane or so may be mentioned.

As for examples of isocyanate cross-linker, tolylene diisocyanate (TDI), hexamethylene diisocyanate (HMDI), isophorone diisocyanate (IPDI), xylylene diisocyanate (XDI), tolylene diisocyanate hydride, diphenylmethane diisocyanate and its hydrogenated forms, polymethylenepolyphenyl polyisocyanate, naphthylene-1,5-diisocyanate, polyisocyanate prepolymer, polymethylol propane modified TDI or so may be mentioned.

As for a metal chelate compound, although chelate compounds wherein the metal element is aluminium, zirconium, titanium, zinc, ferrum, stannum, and the like are exemplified, aluminium chelate compounds are preferable due to its performance.

As for an aluminum chelate compounds, diisopropoxy aluminum monooleylacetoacetate, monoisopropoxy aluminium bisoleylacetoacetate, monoisopropoxy aluminum monooleatemonoethylacetoacetate, diisoprpoxy aluminum monolaurylacetoacetate, diisopropoxy aluminum monostearicacetoacetate, diisopropoxy aluminum monoisostearicacetoacetate, monoisopropxy aluminum mono-N-lauroyl-β-alanate monolaurylacetoacetate, aluminumtris(acetylacetate), monoacetylacetoacetate aluminum bis(2-ethylhexylacetoacetate)chelate, monoacetylacetoacetonate aluminum bis(dodecylacetoacetate)chelate, monoacetylacetonate aluminum bis(oleylacetoacetate)chelate and the like are exemplified.

With respect to 100 parts by weight (in terms of solid portion) of (meth)acryloyl group included compound having a reactive functional group other than energy ray polymerizable group, preferably 3 or more parts by weight (in terms of solid portion), more preferably 5 to 70 parts by weight (in terms of solid portion), further preferably 5 to 50 parts by weight (in terms of solid portion) of cross-linker is blended. When blending amount of the cross-linker is within the above range, suitable rigidity of the anchor coat layer is maintained, and a good bonding property against the base film can be obtained.

Further, in addition to the above components, plasticizer, filler, coloring agent, antistatic agent, flame retardant, photopolymerization initiator, leveling agent, and coupling agent and the like may be blended in the anchor coat layer.

As for an anchor coat layer, it is well-known that an anchor coat composition including the above component is dried and applied on a base film, and pre-cured when necessary. The anchor coat composition may be manufactured by a well-known method, wherein the above mentioned component, the other additive agent, and solvents are mixed and stirred. As for the other additive agent, plasticizer, filler, antioxidizing agent, coloring agent, dye, coupling agent and the like may be mentioned.

As for the solvents, alcohols such as methanol, ethanol, and isopropyl alcohol; ethers such as diethyl ether, diisopropyl ether, dibutyl ether, 1,2-dimethoxyethane, tetrahydrofuran, and 1,4-dioxane; esters such as methyl acetate, ethyl acetate, propyl acetate, butyl acetate, methyl lactate; ketones such as acetone, methylethylketone, methylisobutylketone, diethylketone, and cyclohexanone; amides such as N,N-dimethylformamide, N,N-dimethylacetamide, hexamethylphosphoric triamide, and N-methylpyrrolidone; lactams such as ε-caprolactam; lactones such as γ-lactone, δ-lactone; sulfoxides such as dimethyl sulfoxide, and diethyl sulfoxide; aliphatic hydrocarbons such as pentane, hexane, heptane, octane, nonane, and decane; alicyclic hydrocarbons such as cyclopentane, cyclohexane, and cyclooctane; aromatic hydrocarbons such as benzene, toluene, and xylene; halogenated hydrocarbons such as dichloromethane, chloroform, tetrachloromethane, 1,2-dichloroethane, chloro benzene and the like; and the mixed solutions made of two or more thereof may be mentioned.

Although the used amount of the solvent is not particularly limited, solid content concentration of the anchor coat composition is preferably 10 to 50 wt %.

Coating of the above anchor coat composition may be performed by an ordinary method, and for example a bar coating method, a knife coating method, a meyer bar method, a roll coating method, a blade coating method, a die coating method, a gravure coating method and the like may be performed. It is preferable that the anchor coat composition is coated on one side of the base film to form a coated film, and the coated film is dried at around 50 to 120° C.; thereby an anchor coat layer is formed.

Although the thickness of the anchor coat layer is not particularly limited, for instance, 0.1 to 10 μm is preferable, and 1 to 7 μm is more preferable. By having such thicknesses, the anchor coat layer effectively absorbs the contraction which occurs at the energy ray curing of the energy ray-curable adhesive layer; thus the release between the anchor coat layer and the base film can be suppressed, and also the blocking is less likely to happen.

### (Energy Ray-Curable Adhesive Layer)

An adhesive sheet of the present invention is manufactured by forming the energy ray-curable adhesive layer (hereinafter, may be simply referred as “adhesive layer”) on an anchor coat layer of the above base film.

Energy ray-curable adhesive layer may be formed by various energy ray curable adhesive, which is cured by irradiating the energy rays such as a conventionally known gamma-ray, electron beam, ultraviolet rays, visible light and the like. Above all, ultraviolet ray curable adhesive is preferably used.

As for an ultraviolet rays curing type adhesive, an adhesive wherein acrylic polymer is mixed with a multifunctional ultraviolet ray curable resin can be exemplified. When the adhesive includes acrylic polymer, the affinity with (meth)acryloyl group of the anchor coat layer increases, and that the bonding property between the anchor coat layer and the adhesive layer further increases.

As for a multifunctional ultraviolet ray curable resin, a low-molecular compound having a plurality of photopolymerizable functional group, an urethane acrylate oligomer and the like may be exemplified. Further, the adhesive including an acrylic copolymer having a photopolymerizable functional group on its side-chain may be used. As for a photopolymerizable functional group, the same as exemplified as the energy ray polymerizable functional group of a compound including the energy ray polymerizable functional group in an anchor coat layer can be used. When a photopolymerizable functional group exists in the adhesive layer, photopolymerizable functional group and the energy ray polymerizable group reacts in some cases, and thereby a bonding property is thought to increase. It is preferable to make the photopolymerizable functional group and the energy ray polymerizable functional group of a compound including the energy ray polymerizable functional group of an anchor coat layer, the same. Thereby the affinity between the energy ray-curable adhesive layer and the anchor coat layer increases, and that the bonding property between the energy ray-curable adhesive layer and the anchor coat layer increases. In addition, (meth)acryloyl group is preferable for a photopolymerizable functional group. When (meth)acryloyl group exists in both adhesive layer and anchor coat layer, the affinity between the adhesive layer and the anchor coat layer further increases, and the bonding property therebetween particularly increases, as the reaction between (meth)acryloyl groups easily occurs.

Number of polymerizable group present in 1 g of the energy ray-curable adhesive layer is preferably 0.01 mmol or more, more preferably 0.05 mmol or more, and more preferably 0.1 to 5 mmol. These energy ray-curable adhesive layers show a large difference in adhesivenss before and after the curing. Therefore, the adhesive sheet is securely adhered to an adherend, while adhesiveness remarkably decreases by curing when releasing which makes releasing easy. The effect of improving the bonding property between a base and an energy ray-curable adhesive layer according to the invention will be more effective when the energy ray polymerizable group included in the energy ray-curable adhesive layer is within the above range, and a predetermined amount of contraction stress is induced.

The energy ray-curable adhesive layer can be provided by coating a coating liquid for the adhesive layer for forming the energy ray-curable adhesive layer on the abovementioned anchor coat layer. The energy ray-curable adhesive layer can also be provided by forming an adhesive layer on a release treated face of a release sheet, and then by stacking this adhesive layer on the anchor coat layer of the abovementioned coat film thereby the adhesive layer with the release sheet may be formed. A method to form energy ray-curable adhesive layer is not particularly limited and can use normal method, such as a gravure roll method, a roll-knife method, a blade coating method, a die coating method, and the like.

Although a thickness of energy ray-curable adhesive layer in the present invention is not particularly limited, it is normally within a range of 3 to 200 μm, preferably within a range of 5 to 100 μm, and particularly preferably within a range of 5 to 80 μm. Within these ranges, the adhesiveness of the adhesive sheet to the adherend is maintained. Further, the contraction stress during the curing falls in a suitable range, thus the effect of the present invention, which is to maintain the bonding property between a base film and an energy ray-curable adhesive layer, can be ensured.

A release sheet is not particularly limited. For instance, as for a release sheet base, a film comprising a resin such as polyethylene terephthalate, polypropylene, polyethylene and the like, and their foamed film, glassine paper, coated paper, laminated paper, and the like, in alone or by stacking two or more thereof may be used by itself or by release treating with a release agent such as a silicone, a fluorine, a carbamate including long-chain alkyl group, and the like.

### (Use of an Adhesive Sheet)

Adhesive sheet according to the present invention is preferably used as protection of an unprocessed face of a plate-like member when processing the plate-like member. As for a plate-like member, a thin plate comprising semiconductor wafer, metal, glass, ceramics, and the like may be mentioned. A circuit and the like to be protected are formed on one surface of these thin plates, while the process such as the grinding and the like are carried out on the other surface. When carrying out such process, an adhesive sheet of the invention can be applied to a face where circuit and the like which is to be protected is formed.

After a predetermined working process, an adhesive strength can be effectively decreased by irradiating energy ray to the energy ray curable adhesive. Polymerization and curing of the adhesive is performed by an irradiation of the energy ray, which leads to a decrease of an adhesive strength and the seals between a base and an adhesive is maintained via an anchor coat layer,thereby a plate-like member is likely to release without producing interfacial fracture between the adhesive layer and the base, and the cohesion fracture of the adhesive layer. Accordingly, an adhesive sheet of the present invention is preferable for an electronic component which disfavor residues. Accordingly, an adhesive sheet of the present invention is preferably used particularly for a protection sheet of a circuit face during the backside grinding of a semiconductor wafer. Hereinafter, the backside grinding method of a semiconductor wafer will be further described in detail.

During the backside grinding of the wafer, the energy ray-curable adhesive layer of an adhesive sheet is temporary adhered on a circuit face of a semiconductor wafer where a circuit is formed on its frontside, and then backside of the wafer is grinded with a grinder while protecting the circuit face, thereby a wafer is made into a predetermined thickness.

A semiconductor wafer may be a silicon wafer or may be a compound semiconductor wafer such as gallium-arsenic and the like. A circuit may be formed to the frontside of the wafer surface by various methods, including a generally used conventional method such as an etching method, a liftoff method, and the like. In a circuit formation step of a semiconductor wafer, a predetermined circuit is formed. Thickness of the wafer before grinding is not particularly limited and may be approximately 500 to 1,000 μm or so.

During the backside grinding, an adhesive sheet of the present invention is temporary adhered on a circuit face in order to protect a circuit on a wafer. Note that “the sheet is temporary adhered” defines that “the sheet is removably fixed to an adherend”. The adhesive sheet is temporally adhered to the wafer frontside by a general means such as by using a tape mounter and the like. Further, an adhesive sheet may be cut in advance into about the same shape as a semiconductor wafer; alternatively a sheet may be temporary adhered to the wafer, and then extra sheet may be cut and removed along the wafer outer circumference.

The backside grinding of the wafer is performed under a condition wherein an adhesive sheet is temporary adhered to an entire circuit by a conventionally known method using a grinder and a suction table for fixing the wafer. According to the present invention, a semiconductor wafer is temporary adhered by an energy ray-curable adhesive layer; thereby a wafer is securely held against a shear force during the backside grinding of the wafer. Accordingly, there is no intrusion of grinding water to a circuit face, and that a backside of the wafer can uniformly grinded.

In general, an adhesive sheet is temporary adhered to a wafer circuit face at a room temperature (i.e. 23° C.). In order to surely seal an outer circumference of the wafer and to prevent the inrusion of grinding water, an adhesive sheet on a wafer outer circumference may be heat-stuck, when temporary adhering the adhesive sheet on the wafer circuit face.

Although the thickness of a semiconductor wafer after the backside grinding is not particularly limited, it is preferably 10 to 300 μm or so, more preferably 25 to 200 μm or so.

After the backside grinding, an energy ray is irradiated to an energy ray-curable adhesive layer in order to release an adhesive sheet from the wafer frontside. According to an adhesive sheet of the present invention, when the adhesive sheet is released from the wafer frontside after the backside grinding, a contamination of the wafer frontside by an adhesive sheet-derived residues is extremely low; and thus the occurrence of defective products can be suppressed and the quality of the obtained semiconductor chip is stabilized.

Next, by undergoing steps such as dicing of the wafer, mounting of a chip, a resin sealing, and the like, a semiconductor device is obtained.

Furthermore, an adhesive sheet of the present invention may be used for temporarily fixing the wafer during dicing step of a semiconductor wafer, for a support sheet used when a laser marking is performed to a circuit unformed face of a semiconductor wafer for a semiconductor chip by a face-down method, and for a breaking sheet which supports a plate-like member when braking is performed by having a physical impact on a hard plate-like member and dividing them to a chip.

### EXAMPLE

Hereinafter the present invention will be described based on the examples; however the present invention is not limited thereto. Measurement and evaluation methods of the invention will be described below.

(1) Bonding Property of an Energy Ray-Curable Adhesive Layer

Releasing film was released and removed from an adhesive sheet obtained by the examples and the comparative examples. Ultra violet ray irradiation (230 mW/cm², 190 mJ/cm²) was performed and an energy ray-curable adhesive layer was cured. Next, based on JISK5600-5-6:1999 cross-cut method, the numbers of the cut were set to 10 in each direction of the lattice pattern (a number of a lattice squares were 100), and the space between the cut was set to 5 mm; thereby the bonding property between the anchor coat layer and an energy ray-curable adhesive was evaluated. The number of the lattice squares of which the adhesive was removed, was counted.

(2) Blocking Resistance

5 sheets of base films with an anchor coat layer obtained from the examples and the comparative examples, were stacked and loads of 784 mN/cm² under 40° C. 80% RH (relative humidity) was applied, then left for one week. Next, it was left at 23° C. 50% for 1 day, stacked samples were removed, and then the adhesiveness with the film face were evaluated by the following criteria.
A: No adhesion to the film face
B: Film face and anchor coat face are adhered in points; however, there is no problem to release both faces, and no change can be visually-observed on the anchor coat layer frontside after releasing them.
C: Film face and anchor coat face are adhered and they are unable to release by hand, or they are able to release by hand but a change can be visually-observed on the anchor coat layer frontside after releasing them.

Hereinafter, the compositions of an energy ray-curable adhesive used in the examples and the comparative examples of the invention will be described.

### <The Adhesive 1>

Energy ray curable copolymer having energy ray polymerizable group on its side chain was obtained by a reaction of 100 parts by weight of copolymer having approximately 650 thousands weight-average molecular weight, comprising 85 parts by weight of n-butyl acrylate and 15 parts by weight of 2-hydroxyethylacrylate, and 16 parts by weight of methacryloyloxy ethyl isocyanate. 5 parts by weight of curing agent (additives of tolylene diisocyanate and trimethylolpropane) and 5 parts by weight of photopolymerization initiator (Irgacure 184, made by Ciba Specialty Chemicals Inc.) were added to the energy ray curable copolymer; thereby an adhesive 1 was made. Note that the blending numbers are all in terms of a solid portion.

### <The Adhesive 2>

100 parts by weight of an acrylic adhesive (copolymers of n-butyl acrylate and acrylic acid), 120 parts by weight of a trifunctional urethaneacrylate oligomer, 10 parts by weight of a curing agent (diisocyanates) and 5 parts by weight of photopolymerization initiator (benzophenones) were mixed to make an adhesive 2. Note that the blending numbers are all in terms of a solid portion.

### Example 1

(Base Films with an Anchor Coat Layer)

100 parts by weight of polyester resin solution having acrylate-modified polyester as a main component (ARACOAT AP2500E (made by ARAKAWA CHEMICAL INDUSTRIES, LTD., 50% solid portion)) were added with 60 parts by weight of ARACOAT CL2500 (made by ARAKAWA CHEMICAL INDUSTRIES, LTD., 40% solid portion) as aziridine cross-linker, and an anchor coat layer forming composition was obtained. When 100 parts by weight of acrylate-modified polyester is included as a solid portion, this composition includes 48 parts by weight of an aziridine cross-linker as solid portion (Note that the blending amount of an acrylate-modified polyester and a cross-linker in Example 2 and in subsequent examples are shown in the Table.)

This anchor coat layer forming composition was coated and casted by a gravure roll method on polyethylene terephthalate film (50 μm thickness of Lumirror PET50 T-60, made by Toray Industries, Inc.) so that the thickness after the drying is 1 μm; and then dried for 1 minute at a temperature of 70° C. to obtain polyester base films with an anchor coat layer. Blocking resistance of the base films was evaluated. The results are shown in Table 1.

### (Adhesive Sheet 1)

The adhesive 1 was coated and casted by a roll-knife method on SP-PET381031 as a releasing film so that the thickness after drying is 20μm; and then dried for 1 minute at a temperature of 100° C. to obtain an adhesive layer on a releasing film. An exposed face of the adhesive layer was pasted with an anchor coat layer face of the above polyester base films with an anchor coat layer; thereby the adhesive sheet 1 was obtained wherein polyester film, an anchor coat layer, energy ray-curable adhesive layer and releasing film were stacked in this order. The bonding property of energy ray-curable adhesive layer in the obtained adhesive sheet 1 was evaluated. Results are shown in Table 1.

### (Adhesive Sheet 2)

The same procedures were performed as described above to obtain adhesive sheet 2, except for using adhesive 2 instead of adhesive 1. And the same evaluation was performed. Results are shown in Table 1.

### Example 2

The same procedures were performed as example 1 except for blending amount of aziridine cross-linker: ARACOAT CL2500 (made by ARAKAWA CHEMICAL INDUSTRIES, LTD., 40% solid portion) was 30 parts by weight, and then obtained adhesive sheet 1 using adhesive 1 and adhesive sheet 2 using adhesive 2. Results are shown in Table 1.

### Example 3

The same procedures were performed as described above except for blending amount of aziridine cross-linker: ARACOAT CL2500 (made by ARAKAWA CHEMICAL INDUSTRIES, LTD., 40% solid portion) was 15 parts by weight. Results are shown in Table 1.

### Example 4

The same procedures were performed as described above except for blending amount of aziridine cross-linker: ARACOAT CL2500 (made by ARAKAWA CHEMICAL INDUSTRIES, LTD. made, 40% solid portion) was 7 parts by weight. Results are shown in Table 1.

### Example 5

The same procedures were performed as described above except for aziridine cross-linker: ARACOAT CL2500 (made by ARAKAWA CHEMICAL INDUSTRIES, LTD., 40% solid portion) was not added. Results are shown in Table 1.

### Example 6

The same procedures were performed as example 2 except for the thickness of an anchor coat layer was 0.08 μm. Results are shown in Table 1.

### Example 7

The same procedures were performed as example 2 except for thickness of an anchor coat layer was 0.3 μm. Results are shown in Table 1.

### Example 8

The same procedures were performed as example 2 except for thickness of an anchor coat layer was 3 μm. Results are shown in Table 1.

### Example 9

The same procedures were performed as example 1 except for the thickness of an anchor coat layer was 5 μm. Results are shown in Table 1.

### Example 10

The same procedures were performed as example 1 except for changing polyester resin solution having acrylate-modified polyester as a main component, from ARACOAT AP2500E (made by ARAKAWA CHEMICAL INDUSTRIES, LTD.) to ARACOAT AP2510 (made by ARAKAWA CHEMICAL INDUSTRIES, LTD., 30% solid portion), aziridine cross-linker: ARACOAT CL2500 (ARAKAWA CHEMICAL INDUSTRIES, LTD. made, 40% solid portion) to 10 parts by weight, and thickness of an anchor coat layer to 2 μm. Results are shown in Table 1.

### Example 11

The same procedures were performed as example 1 except for changing polyester resin solution having acrylate-modified polyester as a main component, from ARACOAT AP2500E (made by ARAKAWA CHEMICAL INDUSTRIES, LTD.) to ARACOAT AP2502B2 (made by ARAKAWA CHEMICAL INDUSTRIES, LTD., 50% solid portion), aziridine cross-linker: ARACOAT CL2500 (made by ARAKAWA CHEMICAL INDUSTRIES, LTD.) to 10 parts by weight, and thickness of an anchor coat layer to 2 μm. Results are shown in Table 1.

### Example 12

The same procedures were performed as example 1 except for changing polyester resin solution having acrylate-modified polyester as a main component, from ARACOAT AP2500E (made by ARAKAWA CHEMICAL INDUSTRIES, LTD.) to ARACOAT AP2503A (made by ARAKAWA CHEMICAL INDUSTRIES, LTD., 40% solid portion), and also 60 parts by weight of aziridine cross-linker: ARACOAT CL2500 (made by ARAKAWA CHEMICAL INDUSTRIES, LTD.) was changed to 10 parts by weight of isocyanate cross-linker: ARACOAT CL2503 (made by ARAKAWA CHEMICAL INDUSTRIES, LTD.), and the thickness of an anchor coat layer was changed to 2 μm. Results are shown in Table 1.

### Example 13

The same procedures were performed as example 1 except for changing polyester resin solution having acrylate-modified polyester as a main component, from ARACOAT AP2500E (made by ARAKAWA CHEMICAL INDUSTRIES, LTD.) to ARACOAT AP2503D2 (made by ARAKAWA CHEMICAL INDUSTRIES, LTD., 40% solid portion), and also 60 parts by weight of aziridine cross-linker: ARACOAT CL2500 (made by ARAKAWA CHEMICAL INDUSTRIES, LTD.) was changed to 10 parts by weight of isocyanate cross-linker: ARACOAT CL2503 (made by ARAKAWA CHEMICAL INDUSTRIES, LTD., 40% solid portion), and the thickness of an anchor coat layer was changed to 2 μm. Results are shown in Table 1.

### Comparative Example 1

The same procedures were performed as example 1 except for not having anchor coat layer, and polyethylene terephthalate film and the adhesive layer were directly pasted. Results are shown in Table 1.

### Comparative Example 2

The same procedures were performed as example 1 except for the polyester resin solution, having acrylate-modified polyester as a main component: ARACOAT AP2500E (made by ARAKAWA CHEMICAL INDUSTRIES, LTD.) was changed to 30% solid portion solution wherein a polyester resin non-including compound comprising (meth)acryloyl group: VYLON 600 (TOYOBO CO., LTD. made) was dissolved in methyl ethyl ketone; and 30 parts by weight of aziridine cross-linker: ARACOAT CL2500 (made by ARAKAWA CHEMICAL INDUSTRIES, LTD.) was changed to 10 parts by weight of isocyanate cross-linker: CORONATE HL (made by Nippon Polyurethane Industry Co., Ltd., 30% solid portion) and changing thickness of an anchor coat layer to 2 μm. Results are shown in Table 1.

TABLE 1

| | Polyetser resin (solid portion parts by weight) | | | | | | Crosslinker (solid portion | |
|---|---|---|---|---|---|---|---|---|
| | | | | | | VYLON 600 | parts by weight) | |
| | | | | | | (not including | CL2500 | CL2503 |
| | | | | | | (meth)actyloyl | (aziridine | (isocyanate |
| | AP2500E | AP2510 | AP2502B2 | AP2503A | AP2503D2 | group) | cross-linker) | cross-linker) |
| Example 1 | 100 | | | | | | 48.0 | |
| Example 2 | 100 | | | | | | 24.0 | |
| Example 3 | 100 | | | | | | 12.0 | |
| Example 4 | 100 | | | | | | 5.6 | |
| Example 5 | 100 | | | | | | | |
| Example 6 | 100 | | | | | | 24.0 | |
| Example 7 | 100 | | | | | | 24.0 | |
| Example 8 | 100 | | | | | | 24.0 | |
| Example 9 | 100 | | | | | | 24.0 | |
| Example 10 | | 100 | | | | | 13.3 | |
| Example 11 | | | 100 | | | | 8.0 | |
| Example 12 | | | | 100 | | | | 10.0 |
| Example 13 | | | | | 100 | | | 10.0 |
| Comparative | | | | | | | | |
| Example | | | | | | | | |
| Comparative | | | | | | 100 | | |
| Example | | | | | | | | |

| | Crosslinker | | | | |
|---|---|---|---|---|---|
| | (solid portion | | | | |
| | parts by weight) | | | | |
| | CORONATE | | Bonding property of ultraviolet | | |
| | HL | | ray curable adhesive | | Blocking |
| | (isocyanate | Thickness | (releasing number/100 squires) | | resistance |
| | cross-linker) | (μm) | Adhesive sheet 1 | Adhesive sheet 2 | property |
| Example 1 | | 1 | 0/100 | 0/100 | A |
| Example 2 | | 1 | 0/100 | 0/100 | A |
| Example 3 | | 1 | 0/100 | 0/100 | A |
| Example 4 | | 1 | 0/100 | 0/100 | A |
| Example 5 | | 1 | 0/100 | 0/100 | B |
| Example 6 | | 0.08 | 5/100 | 3/100 | A |
| Example 7 | | 0.3 | 0/100 | 0/100 | A |
| Example 8 | | 3 | 0/100 | 0/100 | A |
| Example 9 | | 5 | 0/100 | 0/100 | A |
| Example 10 | | 2 | 0/100 | 0/100 | A |
| Example 11 | | 2 | 0/100 | 0/100 | A |
| Example 12 | | 2 | 0/100 | 0/100 | B |
| Example 13 | | 2 | 0/100 | 0/100 | A |
| Comparative | | — | 100/100 | 100/100 | A |
| Example | | | | | |
| Comparative | 10 | 2 | 100/100 | 100/100 | A |
| Example | | | | | |

1. An adhesive sheet, comprising:
a base film,
an anchor coat layer including a compound having an energy ray polymerizable group, and
an energy ray curable adhesive layer are stacked in this order.

2. The adhesive sheet as set forth in claim 1, wherein said base film comprises polyester.

3. The adhesive sheet as set forth in claim 2, wherein said polyester comprises polyethylene terephthalate.

4. The adhesive sheet as set forth in claim 1, wherein wherein the energy ray polymerizable group comprises a (meth)acryloyl group.

5. The adhesive sheet as set forth in claim 4, wherein the compound having the energy ray polymerizable group comprises a polymer comprising (meth)acryloyl group.

6. The adhesive sheet as set forth in claim 5, wherein the polymer comprising (meth)acryloyl group is a (meth)acrylate-modified polyester.

7. The adhesive sheet as set forth in claim 1, wherein the compound having energy ray polymerizable group has a reactive functional group other than the energy ray polymerizable group, and the anchor coat layer includes a cross-linker.

8. The adhesive sheet as set forth in claim 1, wherein the energy ray curable adhesive includes an acrylic polymer.

9. The adhesive sheet as set forth in claim 1, wherein the energy ray curable adhesive includes a multifunctional ultraviolet ray curable resin.

10. The adhesive sheet as set forth in claim 1, wherein a thickness of the anchor coat layer is 0.1 to 10 μm.

11. The adhesive sheet as set forth in claim 1, wherein being used for an unprocessed face protection of plate-like member when processing the plate-like member.

12. The adhesive sheet as set forth in claim 11 being used for a circuit face protection of a semiconductor wafer when grinding a backside of the semiconductor wafer.
